(19) United States
(12) Patent Application Publication
(10) Pub. No.: US 2015/0265094 A1
(43) Pub. Date: Sep. 24, 2015

(54) MICROWAVE TURNTABLE PROTECTOR

(71) Applicant: Charles Freeland, Berkeley, CA (US)

(72) Inventor: Charles Freeland, Berkeley, CA (US)

(21) Appl. No.: 14/667,668

(22) Filed: Mar. 24, 2015

Related U.S. Application Data
(60) Provisional application No. 61/969,682, filed on Mar. 24, 2014.

(51) Int. Cl. A47J 36/02; A47J 36/04

(52) U.S. Cl. CPC A47J 36/027; A47J 36/04

(57) ABSTRACT

The Clean Turntable is a circular sheet of thin paper, absorbent paper, cellophane, or combination thereof manufactured in an attractive circular shape with scalloped edges, pre cut to accommodate an entire surface of the turntable of a microwave oven.

### CLAIM OF PRIORITY

This patent application claims priority under 35 USC 119 (e) (1) from U.S. Provisional Patent Application No. 61/969,682, filed Mar. 24, 2014, of common inventorship herewith entitled, “The Clean Turnntable,” which is incorporated herein by reference as though the same were set forth in its entirety.

### FIELD OF INVENTION

The present invention pertains to the field of microwave accessories, and more specifically to the field of microwave protective covers.

### BACKGROUND OF THE INVENTION

The prior art has put forth several designs for protective covers. Among these are:

US Patent 2011/0259882 to Ashley Davis describes a fabric cover for covering objects in a microwave. In an exemplary embodiment, the fabric cover is a fitted fabric cover made from organic or natural cotton material with a drawstring that secures the cover over a microwavable item. The fabric cover for microwave allows food to be heated and keeps the microwave clean by covering the food and preventing it from splattering the inside of the microwave.

US Patent 2009/0283519 to Gloria Newton describes a disposable arcuate sheet of an air permeable, water absorbent and hypoallergenic garment interfacing fabric and a method for using the sheet for protecting microwave ovens against food spills, splashes, spatters and spitting during rotation of a carousel. The disposable sheet is a single layer of conventional interfacing fabric provided in an unbroken and unfolded substantially round or circularly shaped flat pattern sized to cover a rotating carousel of a square or rectangular microwave oven or to cover a food container in the oven. The sheet covers food fully without substantially interfering with the oven walls during rotation of the carousel.

U.S. Pat. No. 5,814,396 to Ron J. Weidner and John C. Miller describes a disposable three layered pad for collecting cooking grease. The top layer is made up of at least one ply of a grease absorptive sheet. The middle layer is a grease resistant sheet. Finally, the bottom layer is an anti stick insulating sheet. The pad is dimensioned to cover a substantial portion of the bottom cooking area of a microwave oven.

None of these prior art references describe the present invention.

### SUMMARY OF THE INVENTION

It is an object of the present invention to provide a protective precut liner to be placed over an interior turntable in a microwave oven.

### BRIEF DESCRIPTION OF THE DRAWINGS

FIG. 1 is a prototypical functional top view showing the present invention in an opened microwave.

FIG. 2 is s prototypical close up view showing the present invention in the opened microwave.

### DETAILED DESCRIPTION OF THE INVENTION

During World War II, two scientists invented the magnetron, a tube that produces microwaves. Installing magnetrons in Britain's radar system, the microwaves were able to spot Nazi warplanes on their way to bomb the British Isles. Several years later, it was discovered by accident that microwaves also cook food. Called the Radar Range, the first microwave oven to go on the market was roughly as large and heavy as a refrigerator. Technological advances and further developments led to a microwave oven that was polished and priced for a consumer kitchen. Consumer's cooking habits were drastically changed by the time and energy saving convenience of the microwave oven. Once considered a luxury, the microwave oven developed into a practical necessity for a fast paced world. An expanding market has produced a style to suit every taste, a size, shape and color to fit any kitchen, and a price to please almost every pocketbook. Options such as convection heat, probe, and sensor cooking meet the needs of virtually every cooking, heating or drying application.

Although the microwave has revolutionized cooking in today's hectic and fast faced world, there is still a drawback to the use of this amazing invention. Particularly, the intense heat which emanates from the radiation tends to over agitate the food that is cooking. As a result, food products such as soups, sauces and other foods marinated in liquids can splatter the interior of the oven, particularly the rotating turntable upon which the food is placed to ensure even heat distribution. Unless such spills are immediately cleaned, the food hardens into an almost impenetrable mess. As many consumers can attest, one of the most time consuming and frustrating cleaning tasks involves scraping food particles from the microwave's turntable.

The present invention, hereinafter referred to as the Microwave Turntable Protector, or Clean Turntable, is a protective, precut liner that is placed over the interior turntable of microwave ovens. The Clean Turntable provides consumers with a simple and effective means of catching food splatters during preparation, alleviating time consuming clean up duties. The present invention is placed directly over the microwave's turntable, serving as a barrier between the turntable and the food to be cooked. In this manner, any spills are absorbed by the Clean Turntable.

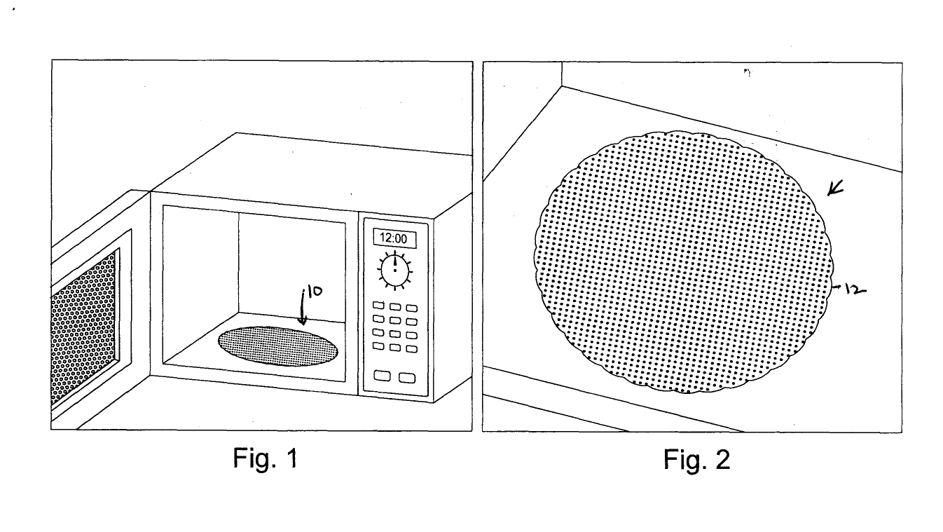

The Clean Turntable is a thin paper, absorbent paper, cellophane, or combination of layers of thin paper, absorbent paper, cellophane sheet 10 manufactured in an attractive circular shape with scalloped edges 12, shown in FIG. 1 and FIG. 2. Pre cut to accommodate an entire surface of the turntable of a microwave oven, the diameter of the Clean Turntable is approximately ten and one quarter inches which is about the size of a common household microwave's turntable. Smaller and larger sheets are available for compact and industrial sized microwave ovens. The Clean Turntable is packaged individually or in bulk with multiple sheets per box.

Use and application of the Clean Turntable is very simple and straightforward. Before cooking a food item in the microwave, a user places a Clean Turntable directly over the turntable, ensuring that the entire surface is covered. While the food is heating, any food splatter that occurs is captured by the sheet without touching the turntable. After use, the Clean Turntable is removed from the oven and disposed in the closest garbage receptacle.

The Clean Turntable provides consumers with a simple and effective means of maintaining a clean, pristine microwave oven. The present invention handily captures spills and splatters that result from intense heat applied to a cooking food product. By simply removing a used Clean Turntable from the microwave, a user presents a microwave oven that looks as clean and new as the day it was purchased. Extremely easy to use, the present invention is applied and removed in a matter of seconds. Primarily conceived for household kitchens, the Clean Turntable also is highly effective for use in restaurants and convenience stores, as these establishments will appreciate its low maintenance aspect.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective precut liner to be placed over an interior turntable in microwave ovens, comprising: a circular sheet with scalloped edges.

2. The protective liner of claim 1 wherein the sheet is comprised of thin paper.

3. The protective liner of claim 1 wherein the sheet is comprised of absorbent paper.

4. The protective liner of claim 1 wherein the sheet is comprised of cellophane.

5. The protective liner of claim 1 wherein the sheet is comprised of a combination of layers of thin paper, absorbent paper, and cellophane.

6. The protective liner of claim 1 wherein the sheet is pre cut to accommodate an entire surface of a turntable of a microwave oven.

7. The protective liner of claim 1 wherein the diameter of the circular sheet is approximately ten and one quarter inches.

8. The protective liner of claim 1 wherein the sheet is packaged individually or in bulk with multiple sheets per box.

9. The protective liner of claim 3 wherein the diameter of the circular sheet is approximately ten and one quarter inches.

10. The protective liner of claim 5 wherein the diameter of the circular sheet is approximately ten and one quarter inches.
